(19) United States
(12) Patent Application Publication
(10) Pub. No.: US 2012/0244370 A1
(43) Pub. Date: Sep. 27, 2012

(54) PRODUCTION OF MINERAL-BONDED COATINGS HAVING DUCTILE PROPERTIES (As Amended)

(75) Inventors: Klas Sorger, Muenchen (DE); Juergen Bezler, Burghausen (DE)

(73) Assignee: WACKER CHEMIE AG, Muenchen (DE)

(21) Appl. No.: 13/514,049

(22) PCT Filed: Dec. 7, 2010
(86) PCT No.: PCT/EP2010/069071

§ 371 Date: Jun. 5, 2012

(30) Foreign Application Priority Data
Dec. 11, 2009 (DE) 102009054563.8

(51) Int. Cl. B32B 27/12; B05D 1/36; B05D 7/14; B32B 27/32

(52) U.S. Cl. 428/523; 427/407.1; 427/409

(57) ABSTRACT

The invention relates to methods for producing mineral bonded coatings, characterized in that that one or more priming agents based on one or more polymers of ethylene unsaturated monomers and optionally one or more components from the group comprising fillers, mineral bonding agents, and fibers is applied to a substrate, and one or more coating agents comprising one or more mineral bonding agents and one or more fibers is/are applied to the priming agent layer thus obtained.

The invention relates to methods of producing mineral-bonded coatings with ductile properties and the coatings obtainable therewith.

Coating compounds based on mineral binders, such as cement, are commonly used building materials and are used for example for coating buildings or infrastructure installations, such as pipelines. However, these coating compounds produce brittle coatings that are characterized by low tensile strength and consequently soon fail and are damaged under dynamic vibratory or bending loading as well as under higher strains. To counteract this deficiency, coatings can be provided with ductile properties. Thus, coatings are desired that only deform plastically under load, without the coatings being damaged. To achieve this, US-A 2002/0019465, US-A 2,005,241534, US-A 2009/0075076 and JP-A 2005001965 recommend cementitious systems, which additionally contain fibers, giving coatings with high ductility and high strength, in particular high compressive strength. These cementitious systems are also known by the term “engineered cementitious composite” or ECC systems or ECC coating compounds and produce coatings in which, on loading, multiple microcracks form instead of one or a few individual larger, brittle cracks or fractures. The ductility of these systems is manifested in their deformation behavior. Thus, even an extension of more than one percent through tensile loading or stress does not lead to failure of the ECC system. JP-A 2002193653 and JP-A 2004324285 describe the use of these ECC coating compounds as sprayable repair mortar. The use of ECC systems for the erection of earthquake-proof buildings is known from JP-A 2000336945. However, there are problems with adhesion of these coatings to the particular substrate, especially in severe mechanical loading, such as occurs during an earthquake. Generally, adhesion is problematic on critical substrates, such as plastic or metal substrates.

The aforementioned problems also arise with pipes for infrastructure installations, for example pipelines. To prevent damage during transport or laying of the pipes, in particular when laying the pipes in stony or rocky ground or also in the backfilling of the corresponding pipe trenches with fill material or rubble, it is proposed in US 2009/0035459 to cover the pipes with fiber-reinforced cementitious coating compounds, i.e. ECC coatings, as a protective layer. However, adhesion of the cementitious protective layer to the pipes again causes problems. These problems arise to a particular extent when coating pipes that are covered with a layer of polyethylene.

Against this background, the problem to be solved was to improve the adhesion of fiber-containing mineral-bonded coatings on substrates, in particular on critical substrates, such as metals or plastics, and to provide coatings that have especially high ductility.

The problem was solved, surprisingly, by first coating the substrate with a polymer-containing primer and only then applying coating compounds containing mineral binders and fibers. The resultant coatings are characterized by strong adhesion to substrates and in addition by ductile behavior even under heavy mechanical loading.

The invention relates to methods of producing mineral-bonded coatings, characterized in that one or more primers based on one or more polymers of ethylenically unsaturated monomers and optionally one or more components from the group comprising fillers, mineral binders and fibers are applied to a substrate and one or more coating compounds containing one or more mineral binders and one or more fibers are applied to the resultant layer of primer.

The invention further relates to mineral-bonded coatings obtainable by applying one or more primers based on one or more polymers of ethylenically unsaturated monomers and optionally one or more components from the group comprising fillers, mineral binders and fibers on a substrate and then applying one or more coating compounds containing one or more mineral binders and one or more fibers.

The primers can contain, as polymers, one or more polymers based on one or more monomers selected from the group comprising vinyl esters, (meth)acrylates, vinyl aromatics, olefins, 1,3-dienes and vinyl halides and optionally other monomers copolymerizable therewith.

Suitable vinyl esters are for example those of carboxylic acids with 1 to 15 carbon atoms. Vinyl acetate, vinyl propionate, vinyl butyrate, vinyl-2-ethylhexanoate, vinyl laurate, 1-methyl-vinyl acetate, vinyl pivalate and vinyl esters of α-branched monocarboxylic acids with 9 to 11 carbon atoms, for example VeoVa9^{R} or VeoVa10^{R} (trade names of the company Resolution) are preferred. Vinyl acetate is especially preferred.

Suitable monomers from the acrylate or methacrylate group are for example esters of linear or branched alcohols with 1 to 15 carbon atoms. Preferred methacrylates or acrylates are methyl acrylate, methyl methacrylate, ethyl acrylate, ethyl methacrylate, propyl acrylate, propyl methacrylate, n-butyl acrylate, n-butyl methacrylate, t-butyl acrylate, t-butyl methacrylate, 2-ethylhexyl acrylate. Methyl acrylate, methyl methacrylate, n-butyl acrylate, t-butyl acrylate and 2-ethylhexyl acrylate are especially preferred.

Styrene, methylstyrene and vinyltoluene are preferred as vinyl aromatics. The preferred vinyl halide is vinyl chloride. The preferred olefins are ethylene, propylene and the preferred dienes are 1,3-butadiene and isoprene.

Optionally a further 0 to 10 wt. % of auxiliary monomers, relative to the total weight of the monomer mixture, can be copolymerized. Preferably 0.1 to 5 wt. % of auxiliary monomers is used. Examples of auxiliary monomers are ethylenically unsaturated mono- and dicarboxylic acids, preferably acrylic acid, methacrylic acid, fumaric acid and maleic acid; ethylenically unsaturated carboxylic acid amides and nitriles, preferably acrylamide and acrylonitrile; mono- and diesters of fumaric acid and maleic acid such as the diethyl and diisopropyl esters and maleic anhydride; ethylenically unsaturated sulfonic acids or salts thereof, preferably vinylsulfonic acid, 2-acrylamido-2-methyl-propanesulfonic acid. Further examples are pre-curing comonomers such as multiply ethylenically unsaturated comonomers, for example diallylphthalate, divinyladipate, diallylmaleate, allylmethacrylate or triallylcyanurate, or post-curing comonomers, for example acrylamidoglycolic acid (AGA), methylacrylamidoglycolic acid methyl ester (MAGME), N-methylolacrylamide (NMA), N-methylolmethacrylamide, N-methylolallylcarbamate, alkyl ethers such as the isobutoxy ethers or esters of N-methylolacrylamide, of N-methylol-methacrylamide and of N-methylolallylcarbamate. Epoxy-functional comonomers such as glycidylmethacrylate and glycidylacrylate are also suitable. Further examples are silicon-functional comonomers, such as acryloxypropyltri(alkoxy)- and methacryloxypropyltri(alkoxy)silanes, vinyltrialkoxysilanes and vinylmethyldialkoxysilanes, wherein for example ethoxy- and ethoxypropyleneglycol-ether residues can be present as alkoxy groups. Mention may also be made of monomers with hydroxyl or CO groups, for example methacrylic acid and acrylic acid hydroxyalkyl esters such as hydroxyethyl, hydroxypropyl or hydroxybutyl acrylate or methacrylate and compounds such as diacetone acrylamide and acetylacetoxyethyl acrylate or methacrylate.

The following are preferred: copolymers of vinyl acetate with 1 to 50 wt. % ethylene; copolymers of vinyl acetate with 1 to 50 wt. % ethylene and 1 to 50 wt. % of one or more further comonomers from the group of vinyl esters with 1 to 12 carbon atoms in the carboxylic acid residue such as vinyl propionate, vinyl laurate, vinyl esters of alpha-branched carboxylic acids with 9 to 13 carbon atoms such as VeoVa9, VeoVa10, VeoVa11; copolymers of vinyl acetate, 1 to 50 wt. % ethylene and preferably 1 to 60 wt. % (meth)acrylates of linear or branched alcohols with 1 to 15 carbon atoms, in particular n-butyl acrylate or 2-ethylhexyl acrylate; and copolymers with 30 to 75 wt. % vinyl acetate, 1 to 30 wt. % vinyl laurate or vinyl esters of an alpha-branched carboxylic acid with 9 to 11 carbon atoms, and to 30 wt. % (meth)acrylates of linear or branched alcohols with 1 to 15 carbon atoms, in particular n-butyl acrylate or 2-ethylhexyl acrylate, which further contain 1 to 40 wt. % ethylene; copolymers with vinyl acetate, 1 to 50 wt. % ethylene and 1 to 60 wt. % vinyl chloride; wherein the polymers can further contain the aforementioned auxiliary monomers in the stated amounts, and the figures in wt. % in each case add up to 100 wt. %.

The following are also preferred: (meth)acrylate polymers, such as copolymers of n-butyl acrylate or 2-ethylhexyl acrylate or copolymers of methyl methacrylate with n-butyl acrylate and/or 2-ethylhexyl acrylate; styrene-acrylate copolymers with one or more monomers from the group methyl acrylate, ethyl acrylate, propyl acrylate, n-butyl acrylate, 2-ethylhexyl acrylate; vinyl acetate-acrylate copolymers with one or more monomers from the group methyl acrylate, ethyl acrylate, propyl acrylate, n-butyl acrylate, 2-ethylhexyl acrylate and optionally ethylene; styrene-1,3-butadiene copolymers; wherein the polymers can further contain the aforementioned auxiliary monomers in the stated amounts, and the figures in wt. % in each case add up to 100 wt. %.

The following are the most preferred: copolymers with vinyl acetate and 5 to 50 wt. % ethylene; or copolymers with vinyl acetate, 1 to 50 wt. % ethylene and 1 to 50 wt. % of a vinyl ester of α-branched monocarboxylic acids with 9 to 11 carbon atoms; or copolymers with 30 to 75 wt. % vinyl acetate, 1 to 30 wt. % vinyl laurate or vinyl esters of an alpha-branched carboxylic acid with 9 to 11 carbon atoms, and 1 to 30 wt. % (meth)acrylates of linear or branched alcohols with 1 to 15 carbon atoms, which further contain 1 to 40 wt. % ethylene; or copolymers with vinyl acetate, 5 to 50 wt. % ethylene and 1 to 60 wt. % vinyl chloride.

Monomer selection and/or selection of the proportions by weight of the comonomers are based on obtaining a glass transition temperature Tg from −50° C. to +50° C., preferably −25° C. to +25° C., especially preferably −20° C. to +10° C. The glass transition temperature Tg of the polymers can be determined in a known way using differential scanning calorimetry (DSC). The Tg can also be calculated approximately beforehand using the Fox equation. According to Fox T. G., Bull. Am. Physics Soc. 1, 3, page 123 (1956) we have: 1/Tg=x1/Tg1+x2/Tg2+ . . . +xn/Tgn, where xn stands for the mass fraction (wt. %/100) of the monomer n, and Tgn is the glass transition temperature in kelvin of the homopolymer of the monomer n. Tg values for homopolymers are given in Polymer Handbook 2nd Edition, J. Wiley & Sons, New York (1975).

In particular, the use of softer polymers, i.e. of polymers with lower glass transition temperature Tg, leads to mineral-bonded coatings that have higher impact strength and ductility and therefore are particularly strong.

Production of the polymers takes place in aqueous medium and preferably by the emulsion or suspension polymerization process—for example as described in DE-A 102008043988. The polymers are in this case obtained in the form of aqueous dispersions. During polymerization, the usual protective colloids and/or emulsifiers can be used, as described in DE-A 102008043988. The following are preferred as protective colloids: partially saponified or fully saponified polyvinyl alcohols with a degree of hydrolysis from 80 to 100 mol. %, in particular partially saponified polyvinyl alcohols with a degree of hydrolysis from 80 to 94 mol. % and a Hoppler viscosity in 4% aqueous solution from 1 to 30 mPas (Hoppler method at 20° C., DIN 53015). The aforementioned protective colloids are accessible by methods known by a person skilled in the art and are generally added during polymerization in a total amount of 1 to 20 wt. %, relative to the total weight of the monomers.

The polymers in the form of aqueous dispersions can be converted, as described in DE-A 102008043988, into corresponding powders that are redispersible in water. In this case, as a rule a drying aid is used in a total amount from 3 to 30 wt. %, preferably 5 to 20 wt. %, relative to the polymer constituents of the dispersion. The aforementioned polyvinyl alcohols are preferred as the drying aid.

Suitable mineral binders are for example cement, in particular Portland cement, high-alumina cement, in particular calcium-sulfo-alumina cement, pozzolanic cement, slag cement, magnesia cement, phosphate cement, or blast-furnace cement, and mixed cements, filling cements, fly-ash, microsilica, granulated blast-furnace slag, slaked lime, hydrated lime, calcium oxide (quicklime) and gypsum. Portland cement, high-alumina cement and slag cement, and mixed cements, filling cements, slaked lime, hydrated lime and gypsum are preferred.

Examples of suitable fillers are quartz sand, quartz flour, powdered limestone, calcium carbonate, dolomite, aluminum silicates, clay, chalk, hydrated lime, talc or mica, or also light-weight fillers such as pumice, foamed glass, aerated concrete, perlites, vermiculites, carbon nanotubes (CNTs). Any mixtures of the aforementioned fillers can also be used. Quartz sand, quartz flour, powdered limestone, calcium carbonate, calcium-magnesium carbonate (dolomite), chalk or hydrated lime are preferred. Powdered limestone, quartz sand, and quartz flour are especially preferred.

The fillers are preferably finely-divided and have for example particle diameters from 0.1 to 6000 μm, preferably 1 to 2000 μm and especially preferably 1 to 600 μm. The finely-divided fillers can be incorporated in the primers or in the coating compounds or in the primers and the coating compounds. With finely-divided fillers, particularly high adhesion can be achieved between the individual layers of the composite comprising substrate, layer of primer and layer of coating compound. This can possibly be attributed to the fact that finely-divided fillers provide particularly efficient keying between the mineral-bonded coating, the primer and/or the substrate or there is especially pronounced interaction between the optionally used polymers and the finely-divided fillers.

The primers can additionally contain one or more fibers. Natural or synthetic fiber materials, based both on organic and inorganic materials, and mixtures thereof, are suitable as fibers. Examples of synthetic organic fibers are Kevlar, viscose, polyamide, and polyester fibers, such as polyethylene terephthalate, polyethylene naphthalate, polycaprolactone fibers, polyacrylate, polyacrylonitrile fibers, polycarbonate, Dralon, polyolefin fibers, such as polyethylene or polypropylene fibers, polyvinyl acetate, polyvinyl alcohol, aramid, polyurethane, polyether ketone, polysulfone, polyethersulfone or carbon fibers. Examples of natural organic fibers are cotton, hemp, jute, flax, wood fibers, cellulose, viscose, leather fibers, sisal, straw, reed or other grasses. Inorganic fibers are for example glass fibers, mineral wool fibers, such as aluminum oxide fibers, or metal fibers. Synthetic organic fibers, such as polyvinyl alcohol fibers, polyacrylonitrile fibers, polyethylene fibers or polypropylene fibers, or mixtures thereof, are preferred. The fibers can be used in the form of loose fibers, fibers glued together in bundles, fibrillated fibers, multifilament fibers or fibers in metering packaging. Sized fibers can also find application, for example fibers sized with paraffin or silicone oil.

Fiber length is preferably 0.1 mm to 200 mm, especially preferably 1 to 100 mm, quite especially preferably 2 to 50 mm and most preferably 4 to 25 mm. Fiber diameter is preferably 5 μm to 80 μm, especially preferably 15 μm to 60 μm and most preferably 25 μm to 45 μm.

Typical recipes for the primers preferably contain 3 to 100 wt. %, especially preferably 3 to 80 wt. %, even more preferably 5 to 55 wt. %, quite especially preferably 10 to 50 wt. % and most preferably 15 to 40 wt. % of polymers; 0 to 95 wt. %, preferably 0 to 50 wt. % and most preferably 5 to 40 wt. % of mineral binders; 0 to 95 wt. %, preferably 30 to 90 wt. % and especially preferably 30 to 80 wt. % of fillers; ≦5 wt. % of fibers; wherein the figures given in wt. % refer to the dry weight of the primers and add up in total to 100 wt. %.

The primers preferably contain 10 to 300 wt. %, especially preferably 10 to 100 wt. %, quite especially preferably 10 to 40 wt. % and most preferably 15 to 40 wt. % of water, in each case relative to the dry weight of the primers. Organic solvents are preferably not present, i.e. preferably are contained to less than 0.1 wt. %, relative to the dry weight of the primers.

Preferred primers contain one or more polymers, one or more fillers, water, optionally one or more mineral binders, optionally one or more fibers, optionally one or more added substances and optionally one or more additives, in each case preferably in the stated amounts. Primers that only contain one or more polymers and water are also preferred. Especially preferred primers do not contain any fibers.

The application properties of the primers can be improved with added substances or additives. Usual added substances for primers are thickeners, for example polysaccharides such as cellulose ethers and modified cellulose ethers, starch ethers, guar gum, xanthan gum, layered silicates, polycarboxylic acids such as polyacrylic acid and partial esters thereof, and polyvinyl alcohols which optionally can be acetalized or hydrophobized, casein and thickeners with associative action. Usual added substances are also retarding agents, such as hydroxycarboxylic acids, or dicarboxylic acids or salts thereof, saccharides, oxalic acid, succinic acid, tartaric acid, gluconic acid, citric acid, sucrose, glucose, fructose, sorbitol, pentaerythritol. Common added substances are also crosslinking agents such as metal or semimetal oxides, in particular boric acid or polyborates, or dialdehydes, such as glutaric dialdehyde; usual additives are accelerators, for example alkali or alkaline-earth salts of inorganic or organic acids. Furthermore, mention may also be made of: hydrophobizing agents (e.g. fatty acids or derivatives thereof, waxes, silanes or siloxanes), preservatives, film-forming aids, dispersants, foam stabilizers, antifoaming agents, liquefiers, flow enhancers and flame retardants (e.g. aluminum hydroxide).

In general the total proportion of added substances and additives in the primers is 0 to 20 wt. %, preferably 0.1 to 15 wt. % and especially preferably 0.1 to 10 wt. %, in each case relative to the dry weight of the primers.

The coating compounds containing mineral binders and fibers are also simply referred to hereinafter as coating compounds. The mineral binders or fibers that are suitable and preferred for the coating compounds are the same mineral binders or fibers listed above correspondingly for the primers. Moreover, the coating compounds can additionally contain one or more polymers, one or more fillers, one or more added substances or one or more additives. As polymers, fillers, added substances or additives, the same embodiments are suitable, preferred, especially preferred and most preferred for the coating compounds as are listed above correspondingly for the primers.

Preferred coating compounds contain one or more mineral binders, one or more fibers, one or more fillers, water, optionally one or more polymers, optionally one or more added substances and optionally one or more additives, in each case preferably in the amounts stated hereunder.

Typical recipes for the coating compounds preferably contain ≦15 wt. %, especially preferably 0 to 10 wt. % and most preferably 0.1 to 7 wt. % of polymers; 10 to 95 wt. %, preferably 30 to 95 wt. % and most preferably to 90 wt. % of mineral binders; 2 to 70 wt. %, preferably 5 to 50 wt. % and especially preferably 10 to 40 wt. % of fillers; preferably 0.1 to 10 wt. %, especially preferably 0.1 to 6 wt. % and most preferably 0.3 to 3 wt. % of fibers; wherein the figures given in wt. % refer to the dry weight of the coating compounds and add up in total to 100 wt. %. A proportion of the binder used can also perform the role of a filler.

The coating compounds preferably contain 5 to 60 wt. %, especially preferably 10 to 40 wt. % and most preferably to 30 wt. % of water, in each case relative to the dry weight of the coating compounds.

However, coating compounds that do not contain any polymer can also be used. To improve the application properties, the coating compounds can additionally contain added substances and optionally additives in the amounts given for the primers.

The production of the primers and/or the coating compounds from the individual ingredients of the respective recipe is not associated with any special procedure or mixing equipment. The individual ingredients can be used during mixing in dry form or optionally in aqueous form, in particular the polymers can be used in the form of aqueous redispersions of water-redispersible powders or preferably in the form of water-redispersible powders or aqueous dispersions. Mixing can take place in the usual mixing equipment. Dry mixtures can also be prepared first. Dry mixtures are obtainable by mixing and homogenizing the individual components of the primers or of the coating compounds to dry mixtures essentially without the water component in conventional powder mixers. In the method according to the invention the water component is added immediately before use of the dry mixtures. The optionally used fibers can be mixed into corresponding dry mixtures or preferably wet mixtures.

The primers or the coating compounds can be applied by the generally known methods for application of coating compounds, for example wet spraying, dry spraying, or manual methods. Common manual methods are application by trowel, brush or knife. Other usual methods are dipping a component in corresponding wet mixtures or introducing the coating compounds into formwork. When using spraying methods, the known devices can be used, for example spraying robots, spraying or sprinkling machines. The primers or the coating compounds are usually prepared and applied at ambient temperatures, i.e. generally at temperatures from 2 to 50° C., in particular 10 to 35° C. It is also possible to submit the applied primers to a thermal treatment to accelerate film formation.

One or more layers of primers can be applied on top of one another. Independently thereof, one or more layers of coating compounds can be applied on top of one another. Optionally, layers of primers can also be applied between layers of coating compounds. After application of aqueous primers, coating compounds can be applied immediately thereafter or with a time delay on the aqueous layer of primer, i.e. provided the layer formed from the primers still contains water.

Alternatively, the coating compounds can also be applied on a dry, i.e. essentially water-free, layer of primer. In the case of application of aqueous primers that contain mineral binders, the coating compounds are preferably applied before the layer of primer has set.

Substrates comprise for example metallic materials, such as steel, aluminum or copper, organic materials, such as plastics, in particular polyethylene, polypropylene, polyvinyl chloride or polystyrene or foams of organic polymers, wood or inorganic materials, such as glass, ceramic, earthenware, stoneware, concrete, brick, metal beams, masonry, roofs, flooring, such as screed or concrete floors, mineral-foam board or plasterboard. Substrates containing metallic materials, in particular steel, or plastics, in particular polyethylene or polypropylene, are preferred. The substrate can be steel beams, pipes, walls, floors, coverings or other surfaces or formwork, pipes being preferred, in particular pipes for pipelines, and the pipes or pipelines can be covered with a protective layer of plastic. In the case of pipes, generally the external surface, i.e. the convex surface, is coated.

The coatings of primers obtainable in this way have a layer thickness of preferably ≦5 mm, especially preferably from 10 μm to 4 mm, and most preferably from 100 μm to 3 mm. The coatings of coating compounds have a layer thickness preferably from 1 mm to 20 cm, especially preferably from 2 mm to 15 cm, and most preferably from 2 mm to 100 mm.

The method according to the invention can thus be applied for producing the common building material coatings, in particular for coating pipelines, for lining tunnels, mines, sewers or for coating floors, walls, roofs, metal beams, pipes as well as for renovation of concrete or for reinforcement of structures.

The procedure according to the invention improves the adhesion between the particular substrate and the fiber-containing, mineral-bonded coating applied thereon. Moreover, the coatings produced according to the invention display excellent ductility, which is manifested in their deformation behavior under the action of external forces, such as tensile loading or stress. Even extension of the coating according to the invention by one percent or more does not lead to its failure. For these reasons the coatings according to the invention are more resistant to mechanical loading, impact or vibratory stress or deformation, which leads for example to a longer service life or durability of building structures. Surprisingly, when soft polymers are used, i.e. using polymers with low glass transition temperature in the primer and optionally also in the coating compound, coatings with especially high ductile behavior are obtained, even when the coatings are applied on critical substrates, such as plastics in particular. This profile of properties is required in particular for structures in earthquake zones or when laying pipelines. Thus, the mineral-bonded coatings produced according to the invention are characterized by high ductility and at the same time by high adhesion to the respective substrate.

The following examples serve for detailed explanation of the invention and are not to be interpreted as any kind of limitation.

### List of Polymers Used:

### Dispersion 1:

Polyvinyl alcohol-stabilized vinyl acetate-ethylene-VeoVa10 terpolymer in the form of an aqueous dispersion with a solids content of 52% and a glass transition temperature of −15° C.

### Dispersion 2:

Polyvinyl alcohol-stabilized methyl methacrylate-butyl acrylate copolymer in the form of an aqueous dispersion with a solids content of 51% and a glass transition temperature of −6° C.

### Dispersion 3:

Polyvinyl alcohol-stabilized styrene-butyl acrylate copolymer in the form of an aqueous dispersion with a solids content of 50.5% and a glass transition temperature of −7° C.

### Dispersible Powder 1:

Polyvinyl alcohol-stabilized vinyl acetate-ethylene copolymer with a glass transition temperature of −7° C.

### Compositions of the Primers:

### Primer 1:

1000 g of dispersion 1.

### Primer 2:

500 g of dispersion 1, 500 g of Durcal 130 (CaCO₃ filler, Omya GmbH Cologne).

### Primer 3:

500 g of dispersion 2, 250 g of Durcal 130 (CaCO₃ filler, Omya GmbH Cologne), 250 g of Portland cement CEM I 52.5 (Milke Geseke Cement Works).

### Primer 4:

500 g of dispersion 3, 125 g of Durcal 40 (CaCO₃ filler, Omya GmbH Cologne), 125 g of quartz sand F36, (Quarzwerke GmbH Frechen), 250 g of Portland cement CEM I 52.5 R (Milke Geseke Cement Works).

### Primer 5:

500 g of dispersion 1, 500 g of Durcal 130 (CaCO₃ filler, Omya GmbH Cologne), 250 g of Portland cement CEM I 52.5 R (Milke Geseke Cement Works), 2 g of Melflux PP 2641 F (BASF).

### Primer 6:

500 g of dispersion 1, 250 g of quartz sand F36 (Quarzwerke GmbH Frechen), 250 g of quartz flour W8 (Quarzwerke GmbH Frechen).

### Primer 7:

750 g of ECC dry mixture, 250 g of dispersible powder 1, 300 g of water.

### Preparation of the Primers:

Primer 1 was used directly. Primers 2 to 7 were prepared by first getting the liquid constituents ready and then adding the powder constituents in the dissolver with stirring (rotary speed: 1000 rpm). Mixing was continued for a further 5 minutes.

### Compositions of the ECC Dry Mixture:

460.00 kg/m³ CEM I 52.5 R Milke Premium (Milke Geseke Cement Works);

800.00 kg/m³ EFA filler KM/C (fly-ash; BauMineral GmbH Herten);

160.00 kg/m³ quartz sand F36 (Quarzwerke GmbH Frechen);

170.00 kg/m³ quartz flour W8 (Quarzwerke GmbH Frechen);

5.30 kg/m³ Melflux PP 2641 F (flow enhancer; BASF);

0.50 kg/m³ Tylose H 15002 P6 (cellulose ether; Shin Etsu).

### Preparation of the Coating Compounds:

The individual ingredients of the ECC dry mixture and optionally dispersible powder 1 were mixed for 10 minutes according to the information in Table 1 in a Toni mixer until homogeneous, and then the water was added. After a mixing time of 5 minutes, the polyvinyl alcohol fibers (PVA fibers) were added and mixing was continued for 5 minutes.

TABLE 1
Composition of the coating compounds:

| | ECC-0 | ECC-1 | ECC-2 | ECC-3 |
|---|---|---|---|---|
| ECC dry mixture [g] | 1000.00 | 990.00 | 980.00 | 960.00 |
| Dispersible powder 1 [g] | — | 10.00 | 20.00 | 40.00 |
| Water [g] | 202.00 | 202.00 | 202.00 | 202.00 |
| PVA fibers [g] | 14.85 | 14.85 | 14.85 | 14.85 |
| Total [g] | 1216.85 | 1216.85 | 1216.85 | 1216.85 |

### Production of the Coatings ((Comparative) Examples ((C.)Ex.) 1 to 10):

The respective primer corresponding to the information in Table 2 was applied with a paint brush in a layer thickness of approx. 1 mm on a polyethylene plate (PE plate; dimensions 40×40×1 cm³). After 25 minutes the respective coating compound was applied 3 mm thick on the respective primer using formwork and then smoothed. The surface of the deposit was sealed with a film against drying out. After 24 hours under standard conditions according to DIN 50014, but at 50% relative air humidity (standard climate), the film and the formwork were removed. The coated PE plate thus obtained was stored for 28 days in standard climate (storage in standard climate (SC)) or, in a second variant, covered with film and stored for 28 days in standard climate (film storage (FS)).

### Testing of Tensile Bond Strength:

Following storage of the respective sample according to storage in standard climate (sample SC) or film storage (sample FS), adhesion was determined from the tensile bond strength according to DIN 18555-6. For this, in each case four points on the respective sample were drilled with an annular bit (diameter: 55 mm), pull-off brackets were glued to the material to be tested and were pulled away by a thrust piston with preselected rate of increase in load. The corresponding tensile bond strength according to DIN 18555-6 was found from the pull-off force determined (kN) and the area (mm²) of the test plug.

### Testing the Ductility of a Mineral-Bonded Coating:

A prism with the dimensions 4×4×16 cm³ was prepared similarly to example 3 and was tested for ductile behavior with the 3-point tensile bend test according to DIN 18555-3. On loading, there was the desired formation of multiple microcracks rather than a single fracture of the prism. After occurrence of the first microcrack, the tensile bend strength rose further to N/mm² and remained constant over a wide range of extension, which is an indication of plastic deformation.

TABLE 2
Structure of the coatings and testing thereof:

| | | | Tensile bond strength | |
|---|---|---|---|---|
| | | Coating | [N/mm²] | |
| | Primer | compound | Specimen SC | Specimen FS |
| C. Ex. 1 | none | ECC-0 | —* | —* |
| C. Ex. 2 | none | ECC-3 | 0.21 | —* |
| Ex. 3 | 1 | ECC-0 | 0.27 | 0.29 |
| Ex. 4 | 1 | ECC-1 | 0.48 | 0.56 |
| Ex. 5 | 1 | ECC-2 | 0.53 | 0.58 |
| Ex. 6 | 1 | ECC-3 | 0.74 | 0.66 |
| Ex. 7 | 2 | ECC-0 | 0.26 | 0.29 |
| Ex. 8 | 2 | ECC-3 | 0.78 | 0.52 |
| Ex. 9 | 3 | ECC-1 | 0.68 | 0.61 |
| Ex. 10 | 4 | ECC-1 | 0.59 | 0.63 |
| Ex. 11 | 5 | ECC-2 | 0.75 | 0.72 |
| Ex. 12 | 6 | ECC-2 | 0.66 | 0.46 |
| Ex. 13 | 7 | ECC-1 | 0.53 | 0.38 |
| Ex. 14 | 7 | ECC-2 | 0.67 | 0.48 |

*Tensile bond strength not measurable, as the coating had detached from the PE plate.

Modification of the ECC coating compound with 4 wt. % of polymer dispersible powder cannot improve the adhesion on the critical polyethylene substrate even after storage in humid conditions (C.Ex. 2 compared to C.Ex. 1). Surprisingly, just the use of a polymer dispersion as primer improves the bond between polyethylene substrate and ECC coating considerably (Ex. 3 to 6 compared to C.Ex. 1 and 2). The soft polymer shows good adhesion to the PE substrate, and the bond effect between polyethylene substrate, primer and ECC coating is maintained even after dynamic loading and impact deformation. Unexpectedly, a slight modification of the ECC coating compound with polymer again leads to a definite increase in tensile bond strength (Ex. 4 to 6 compared to Ex. 3), which explains the outstanding effect of polymers with low glass transition temperature. Primers that contain fine fillers and optionally cement in addition to polymer dispersion can give a further notable increase in bond and adhesion as a result of keying (Ex. 9 and 10).

1-11. (canceled)

12. A method of producing mineral-bonded coatings, comprising:
providing a primer layer on a substrate by applying to the substrate at least one primer based on at least one polymer of ethylenically unsaturated monomers and optionally at least one component selected from the group consisting of fillers, mineral binders and fibers, wherein the at least one polymer has a glass transition temperature Tg from −25° C. to +25° C.; and
applying to the primer layer at least one coating compound comprising at least one mineral binder and at least one fiber.

13. The method as claimed in claim 12, wherein the at least one polymer has a glass transition temperature Tg from −20° C. to +10° C.

14. The method as claimed in claim 12, wherein the at least one primer comprises at least one polymer, at least one filler, water, optionally at least one mineral binder, optionally at least one fiber, optionally at least one added substance and optionally at least one additive.

15. The method as claimed in claim 12, wherein the at least one coating compound comprises at least one mineral binder, at least one fiber, at least one filler, water, optionally at least one polymer, optionally at least one added substance and optionally at least one additive.

16. The method as claimed in claim 15, wherein the at least one fiber is a polyvinyl alcohol fiber or a polyacrylonitrile fiber.

17. The method as claimed in claim 12, wherein the at least one polymer is based on at least one monomer selected from the group consisting of vinyl esters, (meth)acrylates, vinyl aromatics, olefins, 1,3-dienes and vinyl halides and optionally other monomers copolymerizable therewith.

18. The method as claimed in claim 12, wherein the at least one polymer is a member selected from the group consisting of: copolymers of vinyl acetate with 1 to 50 wt. % ethylene; copolymers of vinyl acetate with 1 to 50 wt. % ethylene and 1 to 50 wt. % of one or more other comonomers from the group of vinyl esters with 1 to 12 carbon atoms in the carboxylic acid residue; copolymers of vinyl acetate, 1 to 50 wt. % ethylene and 1 to 60 wt. % (meth)acrylates of linear or branched alcohols with 1 to 15 carbon atoms; copolymers with 30 to 75 wt. % vinyl acetate, 1 to 30 wt. % vinyl laurate or vinyl esters of an alpha-branched carboxylic acid with 9 to 11 carbon atoms, and 1 to 30 wt. % (meth)acrylates of linear or branched alcohols with 1 to 15 carbon atoms, which further contain 1 to 40 wt. % ethylene; and copolymers with vinyl acetate, 1 to 50 wt. % ethylene and 1 to 60 wt. % vinyl chloride; wherein the figures given in wt. % in each case add up to 100 wt. %.

19. The method as claimed in claim 12, wherein the at least one polymer is present in the form of aqueous dispersions or water-redispersible powders, which contain partially saponified or fully saponified polyvinyl alcohols with a degree of hydrolysis from 80 to 100 mol. % and a Floppier viscosity in 4% aqueous solution from 1 to 30 mPas (Floppier method at 20° C., DIN 53015).

20. The method as claimed in claim 12, wherein the fillers have particle diameters from 0.1 to 6000 μm.

21. The method as claimed in claim 12, wherein the substrate comprises organic materials, metallic materials, or other inorganic materials.

22. The method as claimed in claim 12, wherein the substrate is a pipe, a wall, a floor, a covering or other surfaces or formwork.

23. The method as claimed in claim 12, wherein the primer layer has a layer thickness of ≦5 mm.

24. The method as claimed in claim 12, wherein the at least one coating compound has a layer thickness from 1 mm to 20 cm.

25. The method as claimed in claim 12, wherein pipelines, floors, walls, roofs, metal beams, and pipes are coated or tunnels, mines, and sewers are lined or concrete is reconditioned or structures are reinforced.

26. A mineral-bonded coating obtainable by the method of claim 12.

27. The mineral-bonded coating as claimed in claim 26, wherein the at least one polymer is incorporated in the form of aqueous dispersions or water-redispersible powders, which contain partially saponified or fully saponified polyvinyl alcohols with a degree of hydrolysis from 80 to 100 mol. % and a Floppier viscosity in 4% aqueous solution from 1 to 30 mPas (Floppier method at 20° C., DIN 53015).

28. The mineral-bonded coating as claimed in claim 26, wherein the at least one primer contains at least one polymer, at least one filler, water, optionally at least one mineral binder, optionally at least one fiber, optionally at least one added substance and optionally at least one additive.
